(19) United States
(12) Patent Application Publication
(10) Pub. No.: US 2019/0149947 A1
(43) Pub. Date: May 16, 2019

(54) Process for capturing a user's location

(71) Applicant: Software Development Associates, Inc., Palm Beach Gardens, FL (US)

(72) Inventors: Dennis Cunningham, Palm Beach Gardens, FL (US); Roger Dalal, Palm Beach Gardens, FL (US)

(21) Appl. No.: 16/012,389

(22) Filed: Jun. 19, 2018

Related U.S. Application Data
(60) Provisional application No. 62/522,449, filed on Jun. 20, 2017.

(51) Int. Cl. H04W 4/021; H04W 4/08; H04W 64/00

(52) U.S. Cl. CPC H04W 4/021; H04W 64/003; H04W 4/08

(57) ABSTRACT

A method for capturing a user's location and displaying it to viewing users and partner users. The method further includes dynamic communication between virtual boundaries through low frequency radio signals.

### PRIORITY CLAIM

In accordance with 37 C.F.R. §1.76, a claim of priority is included in an Application Data Sheet filed concurrently herewith. Accordingly, the present invention claims priority to U.S. Provisional Patent Application No. 62/522,449, entitled “PROCESS FOR CAPTURING A USER'S LOCATION”, filed Jun. 20, 2017. The contents of which the above referenced application is incorporated herein by reference.

### FIELD OF THE INVENTION

The present invention relates generally to location capture of a particular user in a virtual boundary, and more particularly to immediately displaying captured information to viewing users and partners.

### BACKGROUND OF THE INVENTION

Identifying an individual in a physical setting can be difficult, especially when the individual is in a crowd or an infrequent visitor. This can be troublesome if that setting is an establishment that offers personalized services to individuals, as it is well accepted that recognition of clientele is a key factor in maintaining a beneficial relationship with the clientele.

An individual that is welcomed to an establishment by name is much more likely to frequent the establishment. For instance, if a bartender recognizes an individual entering the bar by name and their preferred drink, that individual will naturally identify with that establishment over another location that does not know their name. This applies to restaurants, bars, retail stores, and any other establishment wherein an individual may frequent.

Additionally, there may be benefits to an individual if that person gains visibility to other individuals currently at a location. Such benefits may include social introductions to new people, meetings with existing relationships such as friends or family members, and/or determinations regarding current traffic levels and wait times.

Finally, the ability for a location to record and optionally identify individuals upon entry and exit to said location can be valuable, providing the ability to determine average length of stay, to calculate increasing or decreasing traffic levels, or to determine number of return visits, and more.

Thus, what is needed in the industry is a method of identifying individuals upon entry to a location as well as the ability to know when those individuals exit.

### SUMMARY OF INVENTION

A method for capturing a user's location and displaying it across a multitude of devices. The method further includes dynamic communication between virtual boundaries to update a user's location. The method further includes displaying the captured information in the assigned order of most recent capture.

An objective of the invention is to disclose a method for capturing a user's location and displaying it across a multitude of devices such as smart phones, tablets, and personal computers.

Still another objective of the invention is to disclose a method that allows communication between virtual boundaries to update a user's location.

Yet still another objective of the invention is to disclose a method of identifying an individual that enters an establishment using radio frequency signals including Bluetooth and/or wi-fi signals transmitted by physical devices potentially combined with other technologies including GPS coordinates to eliminate multiple notifications.

Still another objective of the invention is to link the individual with a database so as to recall the individual's particular drink, food, sports event, family member, or the like information that allows another user or users to immediately familiarize themselves to the individual.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 illustrates the automatic location capture of a user; and

FIG. 2 is a flow diagram of the communication between virtual boundaries and location captures.

### DETAILED DESCRIPTION OF THE INVENTION

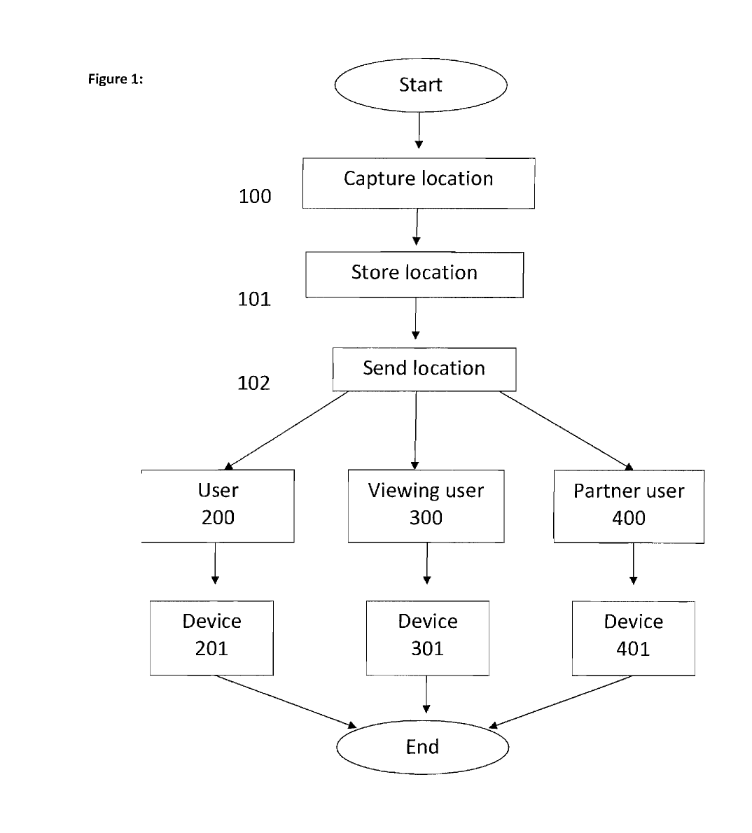

FIG. 1 illustrates the automatic location capture of a user 200. Step 100 shows the location being captured by way of low frequency radio signals and then communicated to step 101 where location capture is stored. Step 102 dynamically sends stored information to devices 201, 301, and 401. Device 201 belongs to user 200. Device 301 belongs to viewing user 300. Device 401 belongs to partnered user 401. User 200 is now displayed across all devices and shown as present at location in step 100.

By way of example, an individual having a smart phone may enter a location. Upon entry, a physical radio frequency device transmits a signal that causes a preinstalled application or applications on the individual's smart phone to report its location and other data to another device, computer server, database, etc. as may be required. The individual is then indicated as being present at the location and optionally displayed across other devices. The system also presents pertinent information about the individual to those connected.

Upon exit of the example location stated above, the user's device may detect the lack or interruption of said location's prior radio frequency signal, and it can then be determined that the user has left that location. Optionally, the user's device may detect that it has moved a set distance from the original point of entry using GPS coordinates, confirming that the user has left that location. In either case the user will no longer appear on other users' devices in that location and their exit will be recorded.

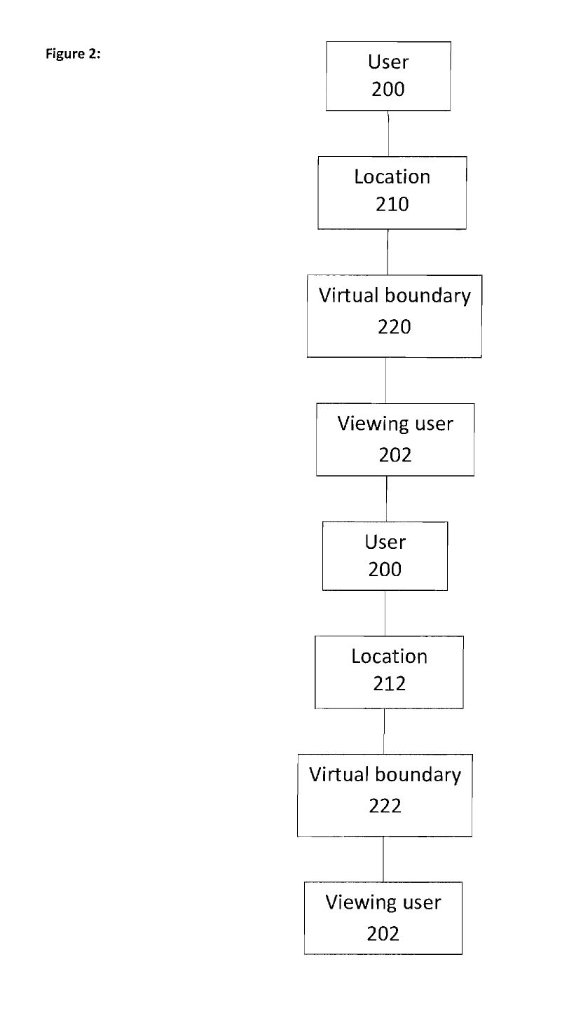

FIG. 2 is a flow diagram of the communication between virtual boundaries and location captures. User 200 enters location 210. User 200's location is captured and automatically assigned virtual boundary 220 and simultaneously displayed on viewing user 202's device. User 200 moves to location 212 and is then re-assigned to location 212's associated virtual boundary 222. User 200's change from location 210 to 212 is displayed on user 202's device. Location 210 is within close vicinity of location 212. Communication occurs between virtual boundaries 220 and 222 making it known that user 200 left location 210 and virtual boundary 220 and entered location 212 and virtual boundary 222. Location 212 is displayed above location 210 on viewing user 202's device.

It is to be understood that while a certain form of the invention is illustrated, it is not to be limited to the specific form or arrangement herein described and shown. It will be apparent to those skilled in the art that various changes may be made without departing from the scope of the invention, and that the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of identifying individual's location using variable distance parameters in a wireless radio communication environment comprising:
receiving a request for a group relative to a defined location;
determining a current location for the group;
identifying those individuals that have entered the defined location and are a member of the group;
retrieving information tagged to said individuals;
displaying individual identity and information tagged to members of said group.

2. The method of claim 1, wherein the request for the group call is received and the individual's location is captured and assigned a virtual boundary.

3. The method of claim 1, wherein the displaying is performed on an individual's dashboard.
